(19) United States
(12) Patent Application Publication
(10) Pub. No.: US 2025/0326406 A1
(43) Pub. Date: Oct. 23, 2025

(54) VEHICLE

(71) Applicant: TOYOTA JIDOSHA KABUSHIKI KAISHA, Toyota-shi Aichi-ken (JP)

(72) Inventors: Kenichi YAMADA, Nisshin-shi Aichi-ken (JP); Hirohito IDE, Nagoya-shi Aichi-ken (JP)

(73) Assignee: TOYOTA JIDOSHA KABUSHIKI KAISHA, Toyota-shi Aichi-ken (JP)

(21) Appl. No.: 19/062,714

(22) Filed: Feb. 25, 2025

(30) Foreign Application Priority Data
Apr. 18, 2024 (JP) 2024-067365

(51) Int. Cl. B60W 60/00; B60W 50/038; B60W 50/04

(52) U.S. Cl. CPC B60W 60/00186; B60W 50/038; B60W 50/045

(57) ABSTRACT

VCIB executes a process including a step of determining whether a communication abnormality has occurred with an ADK, a step of determining whether there is a steering request of an ADK when it is determined that a communication abnormality has occurred with an ADK, and a step of invalidating a steering request of an ADK when it is determined that there is a steering request of an ADK.

### CROSS-REFERENCE TO RELATED APPLICATION

This application claims priority to Japanese Patent Application No. 2024-067365 filed on Apr. 18, 2024, incorporated herein by reference in its entirety.

### BACKGROUND

### 1. Technical Field

The present disclosure relates to a vehicle.

### 2. Description of Related Art

In recent years, there has been developed an autonomous driving system that causes a vehicle to travel without receiving an operation by a user. The autonomous driving system may be provided separately from a vehicle via an interface, in order to be mountable on an existing vehicle, for example.

For an autonomous driving system, Japanese Unexamined Patent Application Publication No. 2021-123140 (JP 2021-123140 A), for example, discloses a technique in which a vehicle platform is steered according to a tire rotation angle command received from the autonomous driving system via a vehicle control interface.

### SUMMARY

In the vehicle described above, when an abnormality occurs in communication with the autonomous driving system, an abnormality may occur in control of the vehicle by the autonomous driving system. When such an abnormality occurs, the vehicle platform takes over control of the vehicle from the autonomous driving system. In this case, it is required to perform appropriate steering during a period since an abnormality occurs in the control of the vehicle by the autonomous driving system until the vehicle platform takes over the control of the vehicle.

The present disclosure has been made in order to address the above issue, and has an object to provide a vehicle that performs appropriate steering when an abnormality occurs in communication with an autonomous driving system.

An aspect of the present disclosure provides a vehicle including: an autonomous driving system; a vehicle platform that executes vehicle control according to a command from the autonomous driving system; and a vehicle control interface that provides an interface between the vehicle platform and the autonomous driving system. When a communication abnormality occurs between the autonomous driving system and the vehicle control interface, the vehicle control interface does not receive a steering request before the communication abnormality occurs.

With such a configuration, in a situation in which the vehicle platform cannot be controlled by the autonomous driving system due to the communication abnormality, the steering control according to the steering request before the occurrence of the communication abnormality is suppressed. Therefore, it is possible to execute control (limp home control, for example) to be performed thereafter without being interfered with by the steering request.

In another aspect, when the communication abnormality occurs, the vehicle control interface may continue control corresponding to an accelerator off state.

With such a configuration, the control corresponding to the accelerator off state performed after the occurrence of the communication abnormality can be executed without being interfered with by the steering request received before the occurrence of the communication abnormality.

In still another aspect, the vehicle platform may include a steering actuator. When the communication abnormality occurs, the vehicle control interface may turn off steering control in which the steering actuator is used.

With such a configuration, the steering control can be turned off without being interfered with by the steering request received before the occurrence of the communication abnormality.

In still another aspect, the autonomous driving system may be configured to be attachable to and detachable from the vehicle platform.

With such a configuration, appropriate steering can be performed when an abnormality occurs in communication with the autonomous driving system configured to be attachable to and detachable from the vehicle platform.

According to the present disclosure, it is possible to provide a vehicle that performs appropriate steering when an abnormality occurs in communication with an autonomous driving system.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of a vehicle according to an embodiment of the present disclosure;

FIG. 2 is a diagram for detailing configurations of an ADS, VCIB and a VP;

FIG. 3 is a flow chart illustrating an exemplary process performed by VCIB; and

FIG. 4 is a diagram for explaining an exemplary operation of VCIB.

### DETAILED DESCRIPTION OF EMBODIMENTS

Hereinafter, an embodiment of the present disclosure will be described in detail with reference to the drawings. In the drawings, the same or corresponding portions are denoted by the same reference signs and the description thereof will not be repeated.

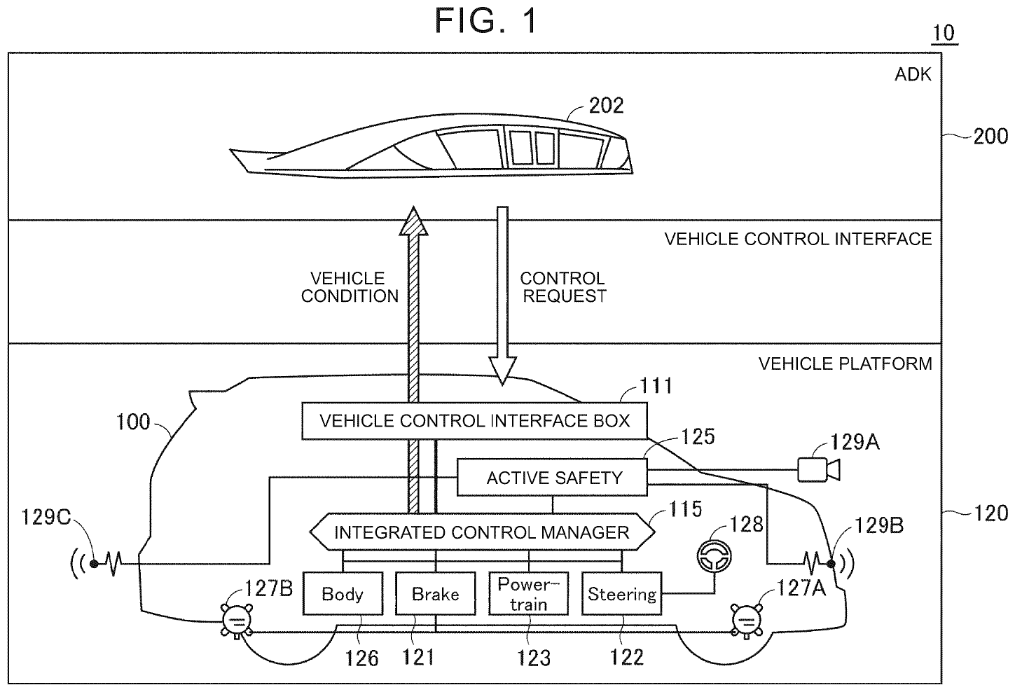

FIG. 1 is a diagram illustrating an outline of a vehicle 10 according to an embodiment of the present disclosure. Referring to FIG. 1, a vehicle 10 includes an autonomous driving kit (hereinafter, referred to as “ADK”) 200 and a vehicle platform (hereinafter, referred to as “VP”) 120. ADK 200 and VP 120 are configured to be able to communicate with each other via a vehicle control interface.

Vehicles 10 can perform automated driving in accordance with a control request (command) from an ADK 200 attached to VP 120. In FIG. 1, although VP 120 and ADK 200 are shown at separate positions, ADK 200 is actually attached to a rooftop or the like of the base-vehicle 100 described later. ADK 200 is configured to be detachable from VP 120. Thus, ADK 200 can also be removed from VP 120. If ADK 200 has been removed, VP 120 can be driven by the user's driving. VP 120 performs travel control according to the manual mode (travel control according to user manipulation).

ADK 200 includes an autonomous driving system (hereinafter referred to as “ADS”) 202 for performing autonomous driving of the vehicles 10. For example, ADS 202 creates a travel plan of the vehicle 10, and outputs various commands (control demands) for causing the vehicle 10 to travel in accordance with the created travel plan to VP 120 in accordance with Application Program Interface (API) defined for each command. Further, ADS 202 receives various signals indicating the state of VP 120 (vehicle state) from VP 120 according to an API defined for each signal, and reflects the received vehicle state in the creation of the travel plan. The detailed configuration of ADS 202 will be described later.

VP 120 includes a base vehicle 100 and a vehicle control interface box (hereinafter referred to as “VCIB”) 111 that implements a vehicle control interface provided in the base vehicle 100.

VCIB 111 can communicate with ADK 200 through Controller Area Network (CAN) or the like. VCIB 111 executes a predetermined API defined for each signal to be communicated, thereby receiving various commands from ADK 200 and outputting the status of VP 120 to ADK 200. That is, upon receiving the control request from ADK 200, VCIB 111 outputs a control command corresponding to the control request to the control command via the integrated control manager 115. Further, VCIB 111 acquires various types of information of the base vehicle 100 from various systems via the integrated control manager 115, and outputs the state of the base vehicle 100 as a vehicle state to ADK 200.

VP 120 includes various systems and various sensors for controlling the base-vehicle 100. Automated driving of the vehicle 10 is performed by VP 120 executing various vehicle controls in accordance with control demands from ADK 200 (specifically, ADS 202). VP 120 includes, for example, a braking system 121, a steering system 122, a power train system 123, an active safety system 125, and a body system 126.

The braking system 121 is configured to be capable of controlling a plurality of braking devices provided on each wheel of the base vehicle 100. The braking device includes, for example, a disc braking system that operates using hydraulic pressure regulated by an actuator.

For example, wheel speed sensors 127A, 127B are connected to the braking system 121. The wheel speed sensor 127A is provided on a front wheel of the base-vehicle 100, for example, and detects a rotational speed of the front wheel. The wheel speed sensor 127A outputs the rotational speed of the front wheel to the braking system 121. The wheel speed sensor 127B is provided on a rear wheel of the base-vehicle 100, for example, and detects a rotational speed of the rear wheel. The wheel speed sensor 127B outputs the rotational speed of the rear wheel to the braking system 121. The wheel speed sensors 127A, 127B output a pulse signal as an output value (pulse value). The number of pulses of the pulse signal may be used to calculate the rotational speed. The braking system 121 outputs the rotational speed of the respective wheels to VCIB 111 as one of the information included in the vehicle state.

The braking system 121 generates a braking command for the braking device according to a predetermined control request outputted from ADK 200 via VCIB 111 and the integrated control manager 115, and controls the braking device using the generated braking command.

The steering system 122 is configured to be able to control the steering angle of the steered wheels of the vehicle 10 by using a steering device. The steering device includes, for example, a rack-and-pinion Electric Power Steering (EPS) in which the steering angle can be adjusted by an actuator.

A pinion angle sensor 128 is connected to the steering system 122. The pinion angle sensor 128 detects a rotation angle (pinion angle) of a pinion gear connected to a rotation shaft of an actuator constituting the steering device. The pinion angle sensor 128 outputs the detected pinion angle to the steering system 122. The steering system 122 outputs the pinion angle to VCIB 111 as one of information included in the vehicle status.

The steering system 122 generates a steering command for the steering device according to a predetermined control request (steering request) outputted from ADK 200 via VCIB 111 and the integrated control manager 115. The steering system 122 controls the steering device using the generated steering command.

The power train system 123 controls an Electric Parking Brake (EPB) provided in at least one of a plurality of wheels provided in the vehicle 10, a parking lock (hereinafter, referred to as a P-Lock) device provided in a transmission of the vehicle 10, a shift device configured to be capable of selecting a shift range of one of the plurality of shift ranges, and a drive source of the vehicle 10. Detailed description will be given later.

The active safety system 125 detects an obstacle or the like (an obstacle or a person) on the front or rear side by using the camera 129A and the radar sensors 129B, 129C, and outputs a braking command to the braking system 121 so that the braking force is increased via the integrated control manager 115 when it is determined that there is a possibility of a collision depending on a distance to the obstacle or the like or a moving direction of the vehicle 10.

The body system 126 is configured to be capable of controlling components such as a direction indicator, a horn, and a wiper according to, for example, a traveling state or a traveling environment of the vehicle 10. The body system 126 controls the above-described components according to predetermined control requirements outputted from ADK 200 via VCIB 111 and integrated control manager 115.

Note that the vehicles 10 may be adopted as one of the configurations of Mobility as a Service (MaaS). MaaS device further comprises, in addition to the vehicles 10, for example, a data server, a Mobility Service Platform (MSPF), and an autonomous driving-related mobility service (neither of which is shown).

Vehicle 10 further comprises a Data Communication Module (DCM) (not shown) as a communication I/F (interface) for wirelessly communicating with the data servers described above. DCM outputs various types of vehicle information such as a speed, a position, and an autonomous driving state to the data server. Further, DCM receives various data for managing the travel of the autonomous vehicle including the vehicle 10 in the autonomous driving related mobility service from the mobility service through MSPF and the data server, for example.

MSPF is a unified platform to which various mobility services are connected. In addition to the mobility services related to autonomous driving, various mobility services (not shown) (for example, various mobility services provided by a ride sharing company, a car sharing company, an insurance company, a rental car company, a taxi company, or the like) are connected to MSPF. Various mobility services including mobility services can utilize various functions provided by MSPF according to service content using API published on MSPF.

The mobility service related to autonomous driving provides a mobility service using an autonomous driving vehicle including the vehicle 10. The mobility service can acquire, for example, driving control data of the vehicles 10 that communicate with the data server, information stored in the data server, and the like from MSPF using API published on MSPF. In addition, the mobility service transmits, for example, data for managing the autonomous vehicle including the vehicle 10 to MSPF using API.

It should be noted that MSPF discloses the vehicle state required for the development of ADS and API for using various data of the vehicle control, and ADS operator can use the vehicle state required for the development of ADS stored in the data server and the data of the vehicle control as API.

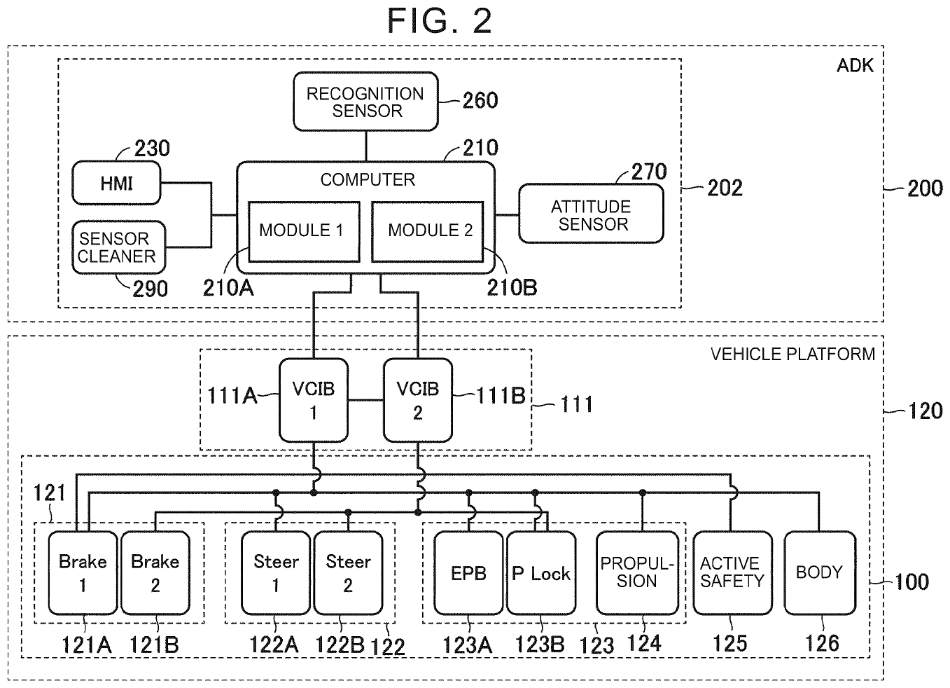

FIG. 2 is a diagram for explaining the configurations of ADS 202, VCIB 111 and VP 120. As illustrated in FIG. 2, ADS 202 includes a computer 210, a Human Machine Interface (HMI) 230, a recognition sensor 260, an attitude sensor 270, and a sensor cleaner 290.

The computer 210 acquires the environment around the vehicle, the attitude, the behavior, and the position of the vehicle by using various sensors, which will be described later, during the automated driving of the vehicle 10, and acquires the vehicle state from VP 120, which will be described later, through VCIB 111 to set the operation (acceleration, deceleration, bending, or the like) of the subsequent vehicle 10. The computer 210 outputs various commands for realizing the set operation of the following vehicles 10 to VCIB 111. The computer 210 includes communications modules 210A, 210B. Each of the communication modules 210A, 210B is configured to be capable of communicating with a VCIB 111.

HMI 230 presents information to the user and accepts an operation at the time of autonomous driving, driving requiring an operation by the user, or at the time of transition between autonomous driving and driving requiring an operation by the user. HMI 230 is configured to be connectable to, for example, a touch panel display provided in the base-vehicle 100 and an input/output device such as a display device and an operating device.

The recognition sensor 260 includes a sensor for recognizing the surroundings of the vehicles 10, and includes, for example, Laser Imaging Detection and Ranging (LIDAR), a millimeter-wave radar, and/or a camera.

LIDAR is a distance measuring device that irradiates a laser beam (infrared ray) in a pulsed manner and measures a distance by a period of time until the laser beam is reflected back to an object. The millimeter wave radar is a distance measuring device that irradiates an object with a radio wave having a short wavelength, detects a radio wave returned from the object, and measures a distance and a direction to the object. The camera is disposed, for example, on a rear side of a room mirror in a vehicle cabin and is used for capturing an image in front of the vehicle. The information acquired by the recognition sensor 260 is output to the computer 210. Other vehicles, obstacles, or persons in front of the vehicle can be recognized by image processing using an artificial intelligence (AI) or an image processing processor for an image or a video captured by the camera.

The attitude sensor 270 includes a sensor that detects the attitude, behavior, or position of the vehicle, and is configured by, for example, Inertial Measurement Unit (IMU), Global Positioning System (GPS), or the like.

IMU detects, for example, accelerations in the front-rear direction, the left-right direction, and the up-down direction of the vehicle, and angular velocities in the roll direction, the pitch direction, and the yaw direction of the vehicle. GPS detects the position of the vehicles 10 using data received from a plurality of GPS satellites orbiting the earth. The information acquired by the attitude sensor 270 is output to the computer 210.

The sensor cleaner 290 is configured to remove dirt that adheres to various sensors during traveling of the vehicle. The sensor cleaner 290 removes, for example, dirt of a lens of a camera, a laser, an irradiation unit of a radio wave, or the like using a cleaning liquid, a wiper, or the like.

VCIB 111 includes a VCIB 111A and a VCIB 111B. VCIB 111A and VCIB 111B include Central Processing Unit (CPU) (not shown) and memories (e.g., Read Only Memory (ROM), Random Access Memory (RAM), etc.) VCIB 111A has the same function as that of VCIB 111B, but the connection destinations for a plurality of systems constituting VP 120 are partially different.

VCIB 111A and VCIB 111B are communicatively connected to the communication module 210A and the communication module 210B of the computer 210, respectively. Further, VCIB 111A and VCIB 111B are communicably connected to each other.

Each of VCIB 111A and VCIB 111B relays various commands corresponding to control demands from ADS 202 and outputs the relayed commands as control commands to VP 120. More specifically, each of VCIB 111A and VCIB 111B generates a control command used for controlling the corresponding system of VP 120 by using various command commands output from ADS 202 by using information (for example, API) such as a program stored in the memory, and outputs the control command to the corresponding system. Each of VCIB 111A and VCIB 111B relays vehicle information output from the respective systems of VP 120 and outputs the vehicle information to ADS 202 as a vehicle state. Note that the information indicating the vehicle status may be the same information as the vehicle information, or may be information obtained by extracting, from the vehicle information, information used in a process executed by ADS 202.

By providing a VCIB 111A and VCIB 111B having equivalent functions for the operation of some systems (e.g., braking and steering), the control system between ADS 202 and VP 120 is made redundant. Therefore, when some kind of failure occurs in a part of the system, the control system can be appropriately switched or the control system in which the failure has occurred can be shut off to maintain VP 120 function (bending, stopping, etc.).

The braking system 121 includes braking systems 121A, 121B. The steering system 122 includes steering systems 122A, 122B. The power train system 123 includes an EPB system 123A, a P-Lock system 123B, and a propulsion system 124. VCIB 111A, the braking system 121A of the plurality of systems of VP 120, the steering system 122A, EPB system 123A, P-Lock system 123B, the propulsion system 124, and the body system 126 are communicatively connected to each other via a communication bus. VCIB 111B, the braking system 121B of the plurality of systems of VP 120, the steering system 122B, and P-Lock 123B are connected to each other via a communication bus so as to be able to communicate with each other.

Each of the braking systems 121A, 121B is configured to be capable of controlling a plurality of braking devices provided on respective wheels of the vehicle. The braking system 121A may have a function equivalent to that of the braking system 121B, or, for example, one of them may be configured to be capable of independently controlling the braking force of each wheel when the vehicle is traveling, and the other may be configured to be controllable so that the same braking force is generated in each wheel when the vehicle is traveling.

The braking systems 121A, 121B generate a braking command for the braking device in accordance with a control demand outputted from ADS 202 via VCIB 111A and VCIB 111B, respectively. The braking systems 121A, 121B control the braking device by using either one of them, and control the braking device by using the other when an anomaly occurs in one of the braking devices.

The steering systems 122A, 122B are configured to be able to control the steering angle of the steered wheels of the vehicle 10 by using a steering device. The steering system 122A has a similar function as compared to the steering system 122B.

The steering systems 122A, 122B generate a steering command for the steering device in accordance with a control demand outputted from ADS 202 via VCIB 111A and VCIB 111B, respectively. The steering systems 122A, 122B control the steering apparatus by using either one of them, and control the steering apparatus by using the other when an anomaly occurs in one of them.

EPB system 123A is configured to be able to control EPB. EPB fixes the wheels by operation of the actuator. EPB system 123A controls EPB according to a control requirement outputted from ADS 202 via VCIB 111A.

P-Lock system 123B is configured to be able to control P-Lock device. P-Lock device 123B controls P-Lock device according to a control request outputted from ADS 202 via VCIB 111A. For example, P-Lock device 123B activates P-Lock device when the control request outputted from ADS 202 via VCIB 111A includes a control request for setting the shift range to the parking range (hereinafter, referred to as the P range), and deactivates P-Lock device when the control request includes a control request for setting the shift range to a range other than the P range.

The propulsion system 124 is configured to be capable of switching a shift range using a shift device, and to be capable of controlling a driving force of the vehicle 10 with respect to a moving direction of the vehicle 10 using a driving source. The switchable shift range includes, for example, a P range, a neutral range (hereinafter, referred to as an N range), a forward travel range (hereinafter, referred to as a D range), and a reverse travel range (hereinafter, referred to as an R range). The drive source includes, for example, a motor generator, an engine, and the like.

The propulsion system 124 controls the shifting device and the drive source according to a control requirement outputted from ADS 202 via VCIB 111A. For example, when the control request outputted from ADS 202 via VCIB 111A includes a control request for setting the shift range to the P range, the propulsion system 124 controls the shift device so that the shift range becomes the P range.

The active safety system 125 is communicatively coupled to the braking system 121A. As described above, the active safety system 125 detects an obstacle or the like (an obstacle or a person) in front using the camera 129A, radar sensor 129B, and when it is determined that there is a possibility of a collision due to a distance with the obstacle or the like, outputs a braking command to the braking system 121A so that the braking force is increased.

The body system 126 controls components such as turn indicators, horns or wipers according to control requirements outputted from ADS 202 via VCIB 111A.

Note that the above-described braking device, steering device, EPB, P-Lock device, shifting device, driving source, and the like may be separately provided with an operating device that can be manually operated by a user.

The various commands corresponding to the control request outputted from ADS 202 to VCIB 111 include a propulsion direction command requesting the switching of the shift range, an immobile command requesting the activation or deactivation of EPB or

P-Lock device, an acceleration command requesting the acceleration or deceleration of the vehicle 10, a tire exhaustion angle command requesting the tire exhaustion angle of the steered wheels, a vehicle mode command requesting the autonomous driving mode of the vehicle mode state, a vehicle mode command requesting the switching of the state with the manual mode, and a stopping command requesting the cancellation of the stop holding or the stop holding of the vehicle.

In the vehicle 10 having the above-described configuration, for example, when the autonomous driving mode is selected as the vehicle mode state by operating HMI 230 of the user or the like, the autonomous driving is performed. As described above, during automated driving, ADS 202 first creates a travel plan. The traveling plan includes, for example, a plan of continuing straight traveling, a plan of turning left or right at a predetermined intersection in the middle of a predetermined traveling route, or a plurality of plans related to the operation of the vehicle 10 such as a plan of changing the traveling lane to a lane different from the lane on which the vehicle travels.

ADS 202 extracts a control physical quantity (for example, acceleration or deceleration, a tire-breaking angle, or the like) required for the vehicles 10 to operate in accordance with the created travel plan. ADS 202 divides the physical quantity for each API run cycle. ADS 202 executes API using the divided physical quantities, and outputs various commands to VCIB 111. Further, ADS 202 acquires a vehicle state (for example, an actual moving direction of the vehicle 10, a state of fixing of the vehicle, and the like) from VP 120, and re-creates a travel plan reflecting the acquired vehicle state. In this way, ADS 202 enables automated driving of the vehicles 10.

For example, when the tire breaking angle command is output to VCIB 111 in accordance with the driving plan of turning right in ADS 202, VCIB 111 instructs the steering system 122 that the steering control is on-state and outputs the input tire breaking angle command. In the steering system 122, when the ON state of the steering control is instructed, the torque generated in the steering actuator is controlled so as to become the tire cutting angle instructed by the tire cutting angle command. When the steering control is instructed to be in the off state, the steering system 122 decreases the torque generated in the steering actuator, and the steering becomes a free state.

When a communication abnormality occurs between ADS 202 and VCIB 111 and a communication abnormality state (for example, a communication interruption state) occurs between ADS 202 and VCIB 111 during the automatic driving of the vehicle 10, the automatic driving control cannot be continued. Therefore, when the communication is abnormal with ADS 202, VCIB 111 takes over the control of the vehicles 10. In this situation, VCIB 111 executes limp home control such as, for example, safely stopping the vehicles 10 on the road shoulder.

However, while the control of the vehicle 10 is handed over to VCIB 111 after the communication abnormal state is reached, the control of the vehicle 10 according to the steering demand received prior to the communication abnormal state may be executed. Therefore, when the limp home control is executed thereafter, there is a possibility that the steering request interferes with the limp home control.

Therefore, in the present embodiment, it is assumed that VCIB 111 does not accept a steering demand prior to a communication abnormality when a communication abnormality occurs between ADS 202 and VCIB 111.

In this way, when VP 120 cannot be controlled by ADS 202 due to a communication abnormality, the steering control according to the steering demand received prior to the communication abnormality is suppressed. Therefore, it is possible to execute control (for example, retreat control) that is performed thereafter without being interfered with the steering request.

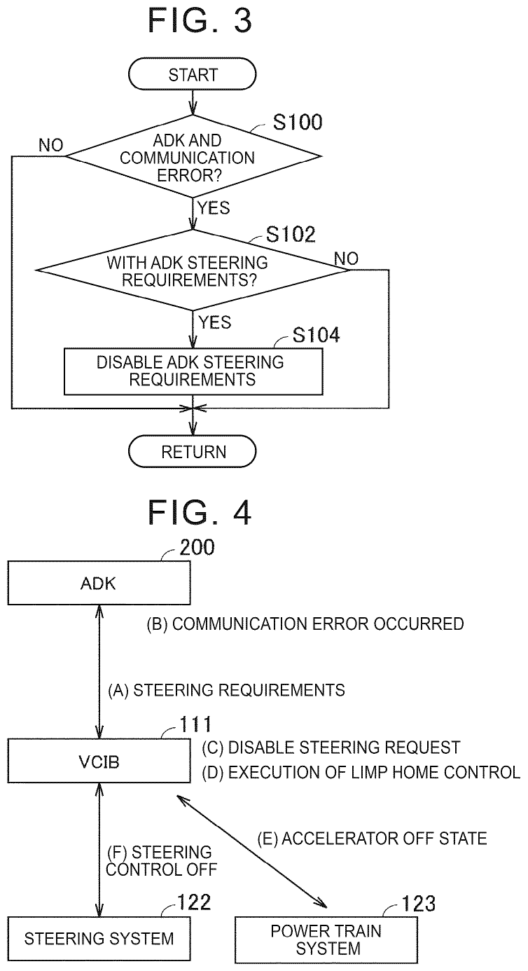

Hereinafter, referring to FIG. 3, a process executed by a VCIB 111 (more specifically, a VCIB 111A) will be described. FIG. 3 is a flow chart illustrating an exemplary process executed by VCIB 111. For example, VCIB 111 repeatedly executes the following processes every API execution cycle.

In step (hereinafter, step is referred to as S) 100, VCIB 111 determines whether an anomaly has occurred in communication with ADK 200. For example, VCIB 111A determines that the communication with the communication module 210A is abnormal when the state in which the various signals are not received from the communication module 210A continues for a predetermined time. VCIB 111B then attempts to communicate with the communication module 210B. Then, VCIB 111B determines that the communication with the communication module 210B is abnormal when the state in which the various signals are not received from the communication module 210B continues for a predetermined time. VCIB 111 determines that an abnormality has occurred in communication with ADK 200 when it is determined that the communication is abnormal both with respect to the communication module 210A and with respect to the communication module 210B.

VCIB 111 may determine that an error has occurred in communication with ADK 200 when receiving a signal that differs from various signals normally received from the communication module 210A or the communication module 210B. If it is determined that an anomaly has occurred in the communication with ADK 200 (YES in S100), the process proceeds to S102.

At S102, VCIB 111 determines whether there is an ADK 200 steering requirement. VCIB 111 determines whether or not a steering-request has been received from ADK 200 within a predetermined time period before the time point at which the communication is determined to be abnormal. For example, VCIB 111 extracts information received from ADK 200 within a predetermined time from a memory such as a buffer, and determines whether or not there is information corresponding to the steering demand. If it is determined that there is a need to steer ADK 200 (YES in S102), the process proceeds to S104.

At S104, VCIB 111 disables ADK 200 steering requirements. VCIB 111 may disable the steering request, for example, by requesting the steering system 122 to turn off the steering control. Alternatively, VCIB 111 may, for example, not send a tire-off-angle command based on the steering demand to the steering system 122. Further, VCIB 111 may invalidate the steering demand and execute the limp home control. The limp home control may include, for example, at least one of a control for turning VP 120 to the accelerator-off state and a steering control for steering the vehicle 10 so as to approach the end of the traveling road surface such as the road shoulder. The process is then terminated.

If no anomaly occurs in communication with ADK 200 (NO in S100) or if there is no ADK 200 steering requirement (NO in S102), this process is terminated.

The operation of VCIB 111 based on the above-described configuration and flow chart will be described referring to FIG. 4. FIG. 4 is a diagram for explaining an operation of VCIB 111.

Hereinafter, it is assumed that, during autonomous driving, as illustrated in (A) of FIG. 4, a communication error occurs between ADK 200 and VCIB 111 after a steering demand is made from ADK 200 to VCIB 111 as illustrated in (B) of FIG. 4. In VCIB 111, if the condition of not receiving various signals from ADK 200 continues until a predetermined time elapses, it is determined that a communication error has occurred with ADK 200 (YES in S100).

At this time, it is determined that there is a steering request that the steering request has been received within a predetermined time period before the time point at which the communication error occurs (YES in S102), and as illustrated in (C) of FIG. 4, the steering request that has been received from ADK 200 is invalidated (S104).

Then, in VCIB 111, as illustrated in (D) of FIG. 4, the limp home control is executed. Therefore, as illustrated in (E) of FIG. 4, a control request for setting the accelerator-off state is transmitted to the power train system 123. As a result, when the vehicle 10 is traveling, the vehicle is in an inertia traveling state. When the vehicle 10 is traveling at a very low speed, a driving force corresponding to creep torque may be applied. At this time, when the braking system 121 is in the non-operating state, the vehicle 10 is maintained in the running state at the extremely low speed.

Further, in VCIB 111, when the limp home control is executed, as illustrated in (F) of FIG. 4, a control request for turning off the steering control is transmitted to the steering system 122. When the steering control is turned off, the torque of the steering actuator gradually decreases and the steering becomes free. In this case, since the steering request received before the occurrence of the communication abnormality is invalidated, the steering control is performed without interfering with the steering request received before the communication abnormality.

As described above, according to the vehicle 10 of the present embodiment, when VP 120 cannot be controlled by ADS 202 due to an abnormality in communication with ADK 200 configured to be detachable, the steering control according to the steering demand received prior to the communication abnormality is suppressed. Therefore, it is possible to execute control (for example, limp home control such as control of the accelerator-off state or off of the steering control) that is performed thereafter without being interfered with the steering request. Therefore, it is possible to provide a vehicle that performs appropriate steering when an abnormality occurs in communication with the autonomous driving system.

Hereinafter, modifications will be described.

In the above-described embodiment, the torque of the steering actuator is gradually reduced by turning off the steering control in the limp home control, but in the limp home control, the torque of the steering actuator may be gradually reduced by gradually changing the required value of the angle of exhaustion of the steering wheel from VCIB 111 to the steering system 122 so as to become neutral (zero-angle of exhaustion).

Further, in the above-described embodiment, the case where the driving force corresponding to the creep torque is applied in the case of the accelerator-off state in the limp home control has been described as an example, but the braking force (the regenerative braking force or the braking force by the hydraulic brake) for stopping the vehicle 10 may be applied in the limp home control.

In addition, the above-mentioned modifications may be carried out by appropriately combining all or a part thereof.

The embodiment disclosed herein should be considered to be exemplary and not restrictive in all respects. The scope of the present disclosure is shown by the scope of claims rather than the description above, and is intended to include all modifications within the meaning and the scope equivalent to the scope of claims.

What is claimed is:

1. A vehicle comprising:
an autonomous driving system;
a vehicle platform that executes vehicle control according to a command from the autonomous driving system; and
a vehicle control interface that provides an interface between the vehicle platform and the autonomous driving system, wherein
when a communication abnormality occurs between the autonomous driving system and the vehicle control interface, the vehicle control interface does not receive a steering request before the communication abnormality occurs.

2. The vehicle according to claim 1, wherein when the communication abnormality occurs, the vehicle control interface continues control corresponding to an accelerator off state.

3. The vehicle according to claim 1, wherein:
the vehicle platform includes a steering actuator; and
when the communication abnormality occurs, the vehicle control interface turns off steering control in which the steering actuator is used.

4. The vehicle according to claim 1, wherein the autonomous driving system is configured to be attachable to and detachable from the vehicle platform.
